(19) United States
(12) Patent Application Publication
(10) Pub. No.: US 2008/0286459 A1
(43) Pub. Date: Nov. 20, 2008

(54) METHOD FOR APPLYING ABRADABLE COATING

(75) Inventor: Kin-Leung Cheung, Toronto (CA)

Correspondence Address: OGILVY RENAULT LLP (PWC), 1981 MCGILL COLLEGE AVENUE, SUITE 1600, MONTREAL, QC, H3A 2Y3, CA

(73) Assignee: PRATT & WHITNEY CANADA CORP., Longueuil (CA)

(21) Appl. No.: 11/749,831

(22) Filed: May 17, 2007

(51) Int. Cl. B05D 1/06

(52) U.S. Cl. 427/201

(57) ABSTRACT

In accordance with one aspect of the invention a process for applying an abradable coating to a component includes cold spraying an abradable coating material in particles towards a target surface of the component.

### TECHNICAL FIELD

The invention relates generally to applying abradable coatings to components and more particularly, to an improved process for applying an abradable coating.

### BACKGROUND OF THE ART

Abradable coatings may be applied to a component surface that is subjected to rubbing or abrasion during operation of the component, such as a blade tip shroud in a gas turbine engine. Abradable coatings typically use porosity to promote fraying of the abradable coating, to prevent blade wear and blade pick up. However, porous abradable coating has leakage paths which adversely affect the seal between the component surface and the blade tips, and thus engine performance.

Accordingly, there is a need to provide an improved process for applying abradable coatings to a component.

### SUMMARY

Provided is a process comprising: (a) providing an abradable coating material in particle form, the abradable coating material including at least one additive selected from a group of silicate mineral powder additives, metal disulfide powder additives, and fluorinated polymer powder additives; and (b) cold spraying the particles of the abradable coating material toward a target surface of the component at a high velocity to cause the particles to deform and adhere to the target surface and do so at a low temperature to prevent oxidation, decomposition, dehydration, chemical reactions, or any change in chemical structure of the particles.

In another aspect, provided is a process for manufacturing a turbine component, the process comprising (a) forming a metal substrate material into a shape of the turbine component; and (b) depositing a layer of abradable coating material in a cold spraying process onto at least a portion of the metal substrate material, the abradable coating material including one of aluminum-silicon type aluminium alloy powders and aluminium bronze type alloy powders, and additives selected from a group of silicate mineral powders, metal disulfide powders, and fluorinated polymer powders.

Further details of these and other aspects will be apparent from the detailed description and figures included below.

### DESCRIPTION OF THE DRAWINGS

Reference is now made to the accompanying figures in which:

FIG. 1 is a schematic cross-sectional view of a gas turbine engine as an example of the application of the present invention;

FIG. 2 is a partial cross-sectional view of the gas turbine engine of FIG. 1, showing an engine component which is manufactured in accordance with the teachings hereof; and

FIG. 3 is a partial cross-sectional view of the turbine component of FIG. 2, showing an abradable coating layer deposited on a surface of the component.

### DETAILED DESCRIPTION OF THE PREFERRED EMBODIMENTS

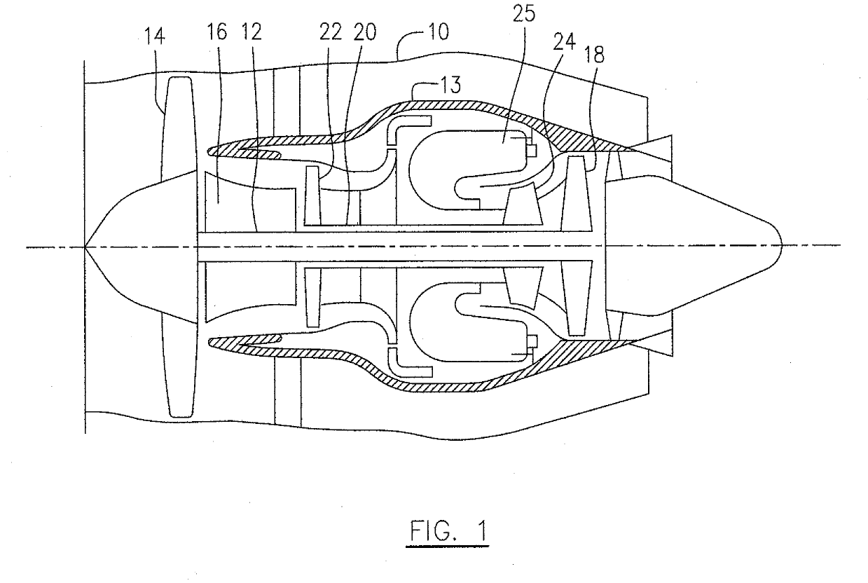

FIG. 1 illustrates a turbofan gas turbine engine which includes a housing or nacelle 10, a core casing 13, a low pressure spool assembly seen generally at 12 which includes a fan assembly 14, a low pressure compressor assembly 16 and a low pressure turbine assembly 18, and a high pressure spool assembly seen generally at 20 which includes a high pressure compressor assembly 22 and a high pressure turbine assembly 24. The core casing 13 surrounds the low and high pressure spool assemblies 12 and 20 in order to define a main fluid path (not indicated) therethrough. In the main fluid path there is provided a combustor seen generally at 25.

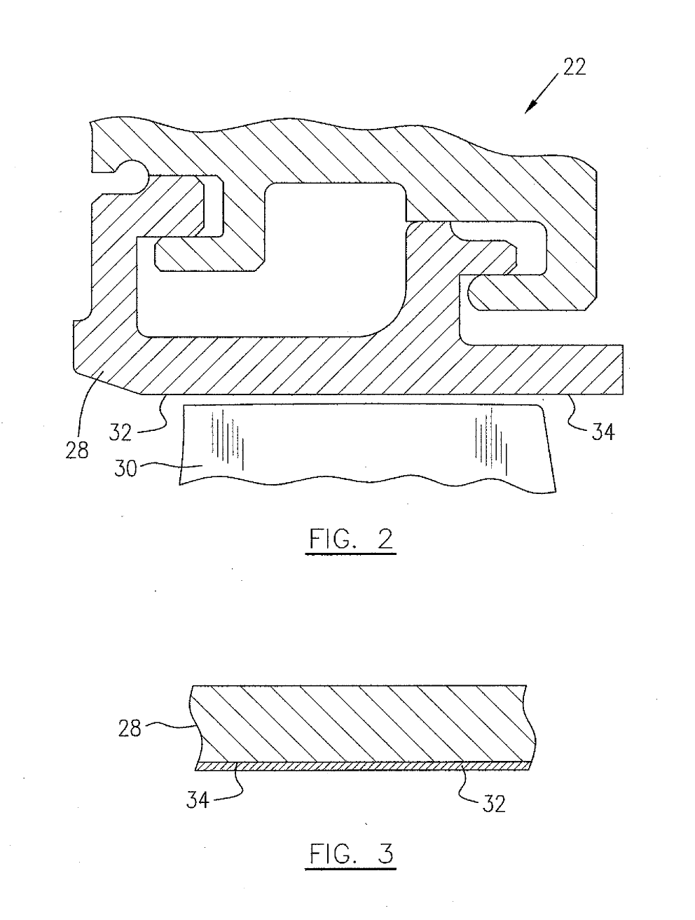

Referring to FIGS. 1-3, abradable coatings are applied to engine casings or blade shrouds in order to improve turbine engine performance. For example, a shroud segment 28 which is a compressor component to form a shroud ring (not indicated) in the high pressure compressor assembly 22 and surrounding high pressure compressor blades 30, may be manufactured to deposit an abradable coating layer 32 onto, for example, an air path surface 34 of the shroud segment 28. The abradable coating layer 32 allows blade rubbing to form a tight sealing surface around the tips of the blades 30, thereby reducing and minimizing air leakages through the gaps between the blade tips and shrouds. The abradable coating layer 32 is typically designed to wear and fray in preference to that of the blades 30 in order to avoid blade damage and wear, and to thereby avoid expensive protective treatment at the blade tips.

In accordance with one aspect of the present teachings, a compressor component such as the shroud segment 28 made of a metallic material in any forming process, is provided to be further treated in a cold spraying process to deposit the layer 32 of abradable coating material onto at least a portion of the shroud segment 28 such as the air path surface 34 thereof. The abradable coating layer 32 includes additives selected from a group of silicate mineral powders, metal disulfide powders, and fluorinated polymer powders.

As used herein, the term “cold spraying” refers generally to a metallization spray process to deposit powder metal onto a substrate. For example, a supersonic jet of helium and/or nitrogen may be formed by a converging/diverging nozzle and is used to accelerate the powder particles toward the substrate to produce cold spray deposits or coatings. Deposits adhere to the substrate and previously deposited layers through plastic deformation and bonding.

The abradable coating material may optionally include aluminium-silicon type aluminium alloy powders, or aluminium bronze type alloy powders.

Prior to the cold spraying process a target surface of the compressor component such as the air path surface 34 is cleaned to remove surface contaminants. Such cleaning may be accomplished by a grit blasting process and/or other cleaning treatments which are known in the art and will not be further described herein.

The cold spray process includes the step of directing particles of the abradable coating material having a predetermined size range, toward a target surface of the component at a velocity sufficiently high, such as at a level of supersonic speed, to cause the particles to deform and to adhere to the target surface. The cold spray process is conducted at a temperature sufficiently low to prevent oxidation, chemical reactions, decomposition, melting, change of chemical structure, dehydration, etc. of the abradable coating material, particularly those of the additives thereof. Optionally, the process temperature may be lower than 500° C. or the process may be operated at an ambient temperature.

In the cold spray process, the kinetic energy of the particles is transformed into plastic deformation of the particles and that of the impacted component substrate surface when the particles strike the target surface of the component, and a bond is thereby formed between the articles and the target surface. The abradable coating layer 32 formed in such a process is a dense coating layer with little or no detrimental thermal affect thereon. The abradable coating layer 32 is a dense coating with low porosity content and thus provides no leakage path in the coating layer. Therefore, the improved coating abradability of the abradable coating layer 32 is not achieved by virtue of coating porosity, but instead by the selected abradable coating material and the selective additives. The abradability of the abradable coating layer 32 is further enhanced and ensured by the low temperature process which prevents the abradable coating material, particularly the selected additives, from undergoing any elevated temperature induced detrimental chemical or physical reactions through the spray process, reactions such as but not limited to oxidation, decomposition, dehydration, change in chemical structure, etc. thereby preserving in full the additive's abradability enhancing characteristics in the coating layer 32. The low temperature process further enables the use of desirable additives which are otherwise not feasible because of the spraying process instability caused by oxidation, chemical reactions, and/or decomposition of the additives at the high process temperatures of conventional thermal spraying techniques such as plasma spraying, high velocity oxy-fuel spraying, etc.

In one embodiment, the aluminium-silicon type aluminium alloy powders which substantially form the abradable coating material for the abradable coating layer 32, include 12% silicon. The aluminium-silicon type alloy powders further include other additives such as mica, talc, molybdenum disulfide, tungsten disulfide, polytetrafluoroethylene polymer, and fluorinated ethylene propylene polymer.

In accordance with another embodiment, the aluminium bronze type alloy powders which may also optionally form the abradable coating material, include 7-12% of copper by weight. The aluminium bronze type alloy powders may further include other additives such as mica, talc, molybdenum disulfide, tungsten disulfide, polytetrafluoroethylene polymer, fluorinated ethylene propylene polymer.

According to a further embodiment, the silicate mineral powder additives are selected from a group of mica and talc.

According to a still further embodiment, the metal disulfide powder additives are selected from a group of molybdenum disulfide and tungsten disulfide.

According to still another further embodiment, the fluorinated polymer powder additives are selected from a group of polytetrafluoroethylene polymer and fluorinated ethylene propylene polymer.

The abradable coating layer 32 may have a ratio between a metallic phase and a non-metallic phase, ranging from 3:7 to 7:3. Therefore, a ratio for mixing metallic powders and non-metallic powders in the coating material should be selected accordingly. During the cold spraying process to deposit the coating material to the target surface of the shroud segment 28, metallic and non-metallic powders may be fed at a varying ratio. Therefore, a desirable distribution of metallic and non-metallic powders through the thickness may be obtained. For example, in the layer 32 of the abradable coating material, more metallic powders may be deposited near the bonding surface to the shroud segment 28 to form a relatively stronger interfacial bond between the shroud segment 28 and the abradable coating layer 32, while more non-metallic powders may be deposited near the outer surface of the abradable coating layer 32 to enhance the abradability of the layer 32. This may be achieved by feeding the respective metallic and non-metallic powders at independent rates to a spraying gun or nozzle. The deposition rates of the respective powders may thus be adjusted to the desired levels through the thickness, one relative to the other during the spraying process.

The apparatus for conducting a cold spraying process to deposit particles on a substrate is known in the art and will not be further described in this application. The coating techniques help preserve the abradability-enhancing characteristics of selected additives in the abradable coating layer. The selected abradable coating material, particularly the selected additives, helps improve dry lubricity at the gas path surface of the shroud ring to prevent blade pick-up and to promote fraying of the coating. The additives also lower coating hardness to reduce blade wear and prevent blade cracks by reducing blade loading at blade rub. Furthermore, the cold spray process deposits the abradable coating layer 32 with reduced ductility by imparting cold work and deformation to the particles that promotes the breaking and the fraying of the coating layer 32 at coating break in. However, the ductility of the abradable coating layer 32 and the erosion resistance thereof will be recovered from elevated temperature exposure upon continued engine running.

The above description is meant to be exemplary only, and one skilled in the art will recognize that changes may be made to the embodiments described without departure from the scope of the inventions disclosed. For example, a shroud segment in a high pressure compressor assembly of the engine was described as an example of the application of the present invention, however the present teachings may be applied to any suitable application requiring abradable coatings. The exemplary shroud segment described in the above embodiments is made from a metallic material, however other materials may be possible for use to form components and/or substrates applicable for the present invention, such as, but not limited to, polymeric type materials, polymeric composite type materials, and particles or fiber reinforced polymeric type materials. Still other modifications will be apparent to those skilled in the art, in light of a review of this disclosure, and such modifications are intended to fall within the scope of the appended claims.

1. A process for applying an abradable coating to a component, the process comprising:
a) providing an abradable coating material in particle form, the abradable coating material including at least one additive selected from the group consisting of silicate mineral powders, metal disulfide powders, and fluorinated polymer powders; and
b) cold spraying the particles of the abradable coating material toward a target surface of the component at a high velocity to cause the particles to deform and adhere to the target surface and doing so at a low temperature to preserve the physical properties, structure, chemistry, and chemical characteristics of the particles.

2. The process as defined in claim 1 wherein the abradable coating material comprises a plurality of aluminium-silicon type aluminium alloy powders.

3. The process as defined in claim 2 wherein the aluminium-silicon type aluminium alloy powders comprise 12 percent of silicon by weight.

4. The process as defined in claim 1 wherein the abradable coating material comprises a plurality of aluminium bronze type alloy powders.

5. The process as defined in claim 4 wherein the aluminium bronze type alloy powders comprise 7-12 percent of copper by weight.

6. The process as defined in claim 1 wherein the abradable coating material comprises silicate mineral powder additives, metal disulfide powder additives and fluorinated polymer powder additives.

7. The process as defined in claim 1 wherein the silicate mineral powder additives are selected from the group consisting of mica and talc.

8. The process as defined in claim 1 wherein the metal disulfide powder additives are selected from the group consisting of molybdenum disulfide and tungsten disulfide.

9. The process as defined in claim 1 wherein the fluorinated polymer powder additives are selected from the group consisting of tetrafluoroethylene polymer and fluorinated ethylene propylene polymer.

10. The process as defined in claim 1 wherein the cold spraying step is conducted at a temperature lower than 500° C.

11. The process as defined in claim 1 wherein the cold spraying step is conducted at an ambient temperature.

12. A process for manufacturing a turbine engine component, the process comprising:
a) forming a metal substrate material into a shape of the turbine component; and
b) depositing a layer of abradable coating material in a cold spraying process onto at least a portion of the metal substrate material, the abradable coating material including one of aluminium-silicon type aluminium alloy powders and aluminium bronze type alloy powders, and additives selected from the group consisting of silicate mineral powders, metal disulfide powders, and fluorinated polymer powders.

13. The process as defined in claim 12 wherein the cold spraying process is conducted at a high velocity to cause the powders to deform and adhere and is conducted at a low temperature to preserve the physical properties, structure, chemistry, and chemical characteristics of the particles.

14. The process as defined in claim 12 wherein the silicate mineral powders are selected from the group consisting of mica and talc.

15. The process as defined in claim 12 wherein the metal disulfide powders are selected from the group consisting of molybdenum disulfide and tungsten disulfide.

16. The process as defined in claim 12 wherein the fluorinated polymer are selected from the group consisting of polytetrafluoroethylene polymer and fluorinated ethylene propylene.

17. The process as defined in claim 12 wherein the aluminium-silicon type aluminium alloy powders comprise 12 percent of silicon by weight.

18. The process as defined in claim 12 wherein the aluminium bronze type alloy powders comprise 7-12 percent of copper by weight.

19. The process as defined in claim 12 wherein, in the abradable coating material a ratio between a metallic phase and a non-metallic phase, is in a range from 3:7 to 7:3 by volume.

20. The process as defined in claim 12 wherein during the cold spraying process in step (b), metallic powders and non-metallic powders are fed at a varying ratio to form the abradable coating material, in order to obtain a desirable distribution of the metallic and non-metallic powders through the thickness of the resulting layer of abradable coating material.
